(19) United States
(12) Patent Application Publication
(10) Pub. No.: US 2021/0339780 A1
(43) Pub. Date: Nov. 4, 2021

(54) DOLLY, PANEL CARRIER AND PANEL LIFT

(71) Applicant: Donald W. Wright, Duncan (CA)

(72) Inventor: Donald W. Wright, Duncan (CA)

(21) Appl. No.: 17/286,200

(22) PCT Filed: Oct. 31, 2019
(86) PCT No.: PCT/CA2019/051545

§ 371 Date: Apr. 16, 2021

Related U.S. Application Data
(60) Provisional application No. 62/754,037, filed on Nov. 1, 2018.

(51) Int. Cl. B62B 1/08; B66F 11/00; B62B 1/14

(52) U.S. Cl. CPC B62B 1/08; B62B 2203/10; B62B 1/14; B66F 11/00

(57) ABSTRACT

An apparatus for carrying construction panels in front and side carry configurations. The apparatus comprising a dolly frame, wheels, a dolly raise assembly so as to permit movement of a car and a load carriage along the dolly frame, a pivot mount hingedly mounted to the car and a load support, wherein the load support is pivotable relative to the pivot mount about a pivot axis between a front carry position and a side carry position. In another embodiment, an apparatus comprising a dolly raise assembly for controlled movement of a load carriage along the longitudinal extent of a dolly frame, and a panel lift fixable to the load carriage for lifting and orienting construction panels for attachment to a wall or ceiling. The panel lift having a lift frame with a panel carriage track, a panel carriage for supporting the panel, and a panel carriage raise assembly for controlled movement of the panel carriage along the panel carriage track.

### CROSS REFERENCE TO RELATED APPLICATIONS

This application claims the benefit of U.S. Provisional Patent Application No. 62/754,037, filed 1 Nov. 2018.

### FIELD OF THE INVENTION

The present invention relates to the field of the handling of loads, including construction panels.

### BACKGROUND OF THE INVENTION

Various forms of power assisted lift devices are known. For example, as disclosed in Price et al. (US 2005/0039256); Hall (GB 2,428,662); Petrini (U.S. Pat. No. 3,940,808); Hunkeler (EP 1,166,741); Schoolden (U.S. Pat. No. 3,937,519); Komura et al. (U.S. Pat. No. 6,783,179); Hedrick (U.S. Pat. No. 5,390,943); Seibert (U.S. Pat. No. 8,915,504); Dion (FR 2496034); Duncan et al. (EP 0952066); Bossi et al. (WO 2012/110397); and Wright (US 2017/0066462).

Due to their weight and configuration (which makes movement in confined spaces or through narrow openings, awkward), construction panels (e.g., plywood, drywall sheets etc.) for attachment to internal walls and ceilings are typically moved one by one to their installation locations within a building. The known so-called panel carriers generally consist of simple hand tools configured to enable a person to grip or support a single panel when transporting it by hand.

Dedicated drywall and panel lifts are known. They generally consists of a three-wheeled base, a telescoping lift component, a reel and pulley arrangement for manually un-telescoping the lift component and a generally H-shaped panel support attached to the upper end of the lift component in a manner that enables the user to set a desired panel orientation (e.g., vertical for a wall or horizontal for a ceiling).

### SUMMARY OF THE INVENTION

In one aspect, the present invention provides an apparatus for use with construction panels, the apparatus providing: two panel carrying positions, one with the panels extending athwart the direction of travel (e.g., for use in moving panels over uneven terrain) and another with the panels aligned with the direction of travel (e.g., for passing through doorways); means for moving panels between the athwart and travel-aligned position; and means for lifting and orienting panels for attachment to a wall or ceiling.

In another aspect, the present invention provides an apparatus for carrying loads on a supporting surface, the loads including construction panels, each construction panel defining a notional unbounded construction panel plane, the apparatus including: a dolly frame having a front, two sides and a back; two wheels, each mounted on a respective side of the dolly frame, with both wheels rotatable about a single common wheel axis, and each wheel having an outer circumference wherein the outer circumferences of the wheels define a notional wheel cylinder extending between the wheels; a load carriage comprising a load support having: a load ledge for supporting loads and defining a load ledge plane; and a load ledge body for stabilizing loads and defining a load ledge body plane; wherein the load ledge plane and load ledge body plane intersect at a load ledge line; and wherein the load support is reversibly user-moveable relative to the dolly frame between: a front carry position wherein the load ledge line is substantially parallel to the wheel axis of rotation; and a side carry position wherein the load support is usable to carry at least one construction panel, with each such carried construction panel's construction panel plane intersecting the wheel cylinder and substantially normal to the wheel axis.

In the side carry position, the load ledge line may intersect the wheel cylinder.

The dolly frame may have a longitudinal extent; and the load carriage may be in slidable engagement with the dolly frame so as to permit reversible movement of the load support along the longitudinal extent of the dolly frame. The apparatus may include a dolly raise assembly for reversible user-controlled movement of the load carriage along the longitudinal extent of the dolly frame. The dolly raise assembly may include a dolly linear actuator.

The load carriage may include: a car in the slidable engagement with the dolly frame; and a hinged relationship between the load support and the car; wherein the reversible user movement of the load support relative to the dolly frame between the front carry position and the side carry position, may involve: the reversible movement of the car along the longitudinal extent of the dolly frame; and hinged movement of the load support relative to the car.

The hinged relationship between the load support and the car may be provided by a pivot mount interposed between the load support and the car, wherein: the pivot mount may be hingedly mounted to the car; and the load support may be pivotably mounted to the pivot mount wherein the load support may be pivotable relative to the pivot mount about a pivot axis substantially normal to the load ledge body plane; and the reversible user movement of the load support relative to the dolly frame between the front carry position and the side carry position, may include the pivotal movement of the load support relative to the pivot mount.

The apparatus may include a back roller attached to the dolly frame wherein the dolly frame is user tiltable between a substantially upright orientation in which the back roller does not contact the supporting surface and a stable tilted orientation in which the wheels and back roller contact the supporting surface; and wherein, in the reversible user movement of the load carriage relative to the dolly frame to the side carry position, the pivotal movement of the load support relative to the pivot mount orients the load ledge line to be substantially parallel to the supporting surface, in the stable tilted orientation. The back roller may be a caster and the attachment of the caster to the dolly frame may include a caster mount user foldable between a retracted position and a projecting position.

The dolly frame may include a frame top and the apparatus may include a hand grip in the vicinity of the frame top; and a brake assembly including: a brake lever adjacent the hand grip and user moveable between a no brake position and a full brake position; a brake mechanism at each wheel; and a brake linkage interconnecting the brake lever and brake mechanism; wherein the brake lever is positioned relative to the hand grip to permit the user to one-handedly grip the hand grip and brake lever in the full brake position.

The apparatus may include a panel lift releasably affixable to the load carriage for user selectively lifting and orienting a construction panel for attachment to a wall or ceiling. The panel lift may include: a lift frame including: at a proximal end of the lift frame, a load ledge engagement means for engagement with the load ledge in the affixing of the panel lift to the load carriage; a panel carriage track extending from the vicinity of the proximal end to a distal end, the panel carriage track including: a vertical track section extending from the vicinity of the proximal end; a horizontal track section at the distal end; and a curved track section connecting the vertical track section and horizontal track section; a panel carriage in slidable engagement with the panel carriage track and including a single-panel ledge for supporting a construction panel; a panel carriage raise assembly for reversible user-controlled movement of the panel carriage along the panel carriage track; whereby, with the panel lift affixed to the load carriage, lifting and orienting a construction panel supported by the single-panel ledge, for attachment to: a ceiling involves: using the panel carriage raise assembly to move the panel carriage and supported panel to the horizontal track section; and then using the dolly raise assembly to raise the panel assembly to bring the construction panel adjacent the ceiling; and a wall involves: using the panel carriage raise assembly along the vertical track section and/or using the using the dolly raise assembly to raise the panel assembly, to move the construction panel to a desired height on the wall.

The dolly raise assembly may include a dolly linear actuator and the panel carriage raise assembly may include a lift linear actuator.

The lift linear actuator may be held in a rigid relationship with the lift frame and a connecting bar may be interposed between the lift linear actuator and the panel carriage to accommodate changing orientations of the panel carriage during movement of the panel carriage between the vertical track section and the horizontal track section via the curved track section. A battery is mounted in the dolly frame to power the dolly linear actuator and, when the panel lift is affixed to the load carriage, the battery may be connectable to the lift linear actuator to power the lift linear actuator.

In another aspect, the present invention provides an apparatus for carrying loads on a supporting surface, the loads including construction panels, each construction panel defining a notional unbounded construction panel plane, the apparatus including: a dolly frame having a front, two sides, a back and a longitudinal extent; two wheels, each mounted on a respective side of the dolly frame, with both wheels rotatable about a single common wheel axis, and each wheel having an outer circumference wherein the outer circumferences of the wheels define a notional wheel cylinder extending between the wheels; a load carriage including: a car in the slidable engagement with the dolly frame so as to permit reversible movement of the car along the longitudinal extent of the dolly frame; a pivot mount hingedly mounted to the car; and a load support, comprising a load ledge for supporting loads and defining a load ledge plane; and a load ledge body for stabilizing loads and defining a load ledge body plane; wherein the load ledge plane and load ledge body plane intersect at a load ledge line; wherein the load support is pivotably mounted to the pivot mount wherein the load support is pivotable relative to the pivot mount about a pivot axis substantially normal to the load ledge body plane; and a dolly raise assembly for reversible user-controlled movement of the car along the longitudinal extent of the dolly frame; wherein the load support is reversibly user-moveable relative to the dolly frame between: a front carry position wherein the load ledge line is substantially parallel to the wheel axis of rotation; and a side carry position wherein the load ledge line intersects the wheel cylinder and the load carriage is usable to carry at least one construction panel, with each such carried construction panel's construction panel plane intersecting the wheel cylinder and substantially normal to the wheel axis; wherein the reversible user movement of the load carriage relative to the dolly frame between the front carry position and the side carry position, involves: the reversible movement of the car along the longitudinal extent of the dolly frame; the hinged movement of the load support relative to the car; and the pivotal movement of the load support relative to the pivot mount.

The dolly raise assembly may include dolly linear actuator.

The apparatus may include a back roller attached to the dolly frame wherein the dolly frame may be user tiltable between a substantially upright orientation in which the back roller does not contact the supporting surface and a stable tilted orientation in which the wheels and back roller contact the supporting surface; and wherein, in the reversible user movement of the load carriage relative to the dolly frame to the side carry position, the pivotal movement of the load support relative to the pivot mount orients the load ledge line to be substantially parallel to the supporting surface, in the stable tilted orientation.

In another aspect, the present invention provides an apparatus for carrying loads on a supporting surface and for user selectively lifting and orienting a construction panel for attachment to a wall or ceiling, the apparatus comprising: a dolly frame having a front, two sides, a back and a longitudinal extent; two wheels mounted to the dolly frame and a having a single common axis of rotation; a load carriage in slidable engagement with the dolly frame so as to permit reversible movement of the load carriage along the longitudinal extent of the dolly frame; a dolly raise assembly for reversible user-controlled movement of the load carriage along the longitudinal extent of the dolly frame; and a panel lift releasably affixable to the load carriage and comprising: a lift frame comprising: at a proximal end of the lift frame, a load carriage engagement means for engagement with the load carriage in the affixing of the panel lift to the load carriage; a panel carriage track extending from the vicinity of the proximal end to a distal end, the panel carriage track comprising: a vertical track section extending from the vicinity of the proximal end; a horizontal track section at the distal end; and a curved track section connecting the vertical track section and horizontal track section; a panel carriage in slidable engagement with the panel carriage track and comprising a single-panel ledge for supporting a construction panel; a panel carriage raise assembly for reversible user-controlled movement of the panel carriage along the panel carriage track; whereby, with the panel lift affixed to the load carriage, lifting and orienting a construction panel supported by the single-panel ledge, for attachment to: a ceiling involves: using the panel carriage raise assembly to move the panel carriage and supported panel to the horizontal track section; and then using the dolly raise assembly to raise the panel assembly to bring the construction panel adjacent the ceiling; and a wall involves: using the panel carriage raise assembly along the vertical track section and/or using the using the dolly raise assembly to raise the panel assembly, to move the construction panel to a desired height on the wall.

The apparatus may also include a user operable kick stand attached to the dolly frame for stabilizing the apparatus when lifting and orienting a construction panel.

### SUMMARY OF THE DRAWINGS

FIG. 1 is an elevation view of the left side of the dolly-panel carrier of the present invention shown in the vertical orientation with the load support at the front and down.

FIG. 2 is an elevation view of the left side of the dolly-panel carrier of FIG. 1 shown in the vertical orientation with the load support at the front and raised.

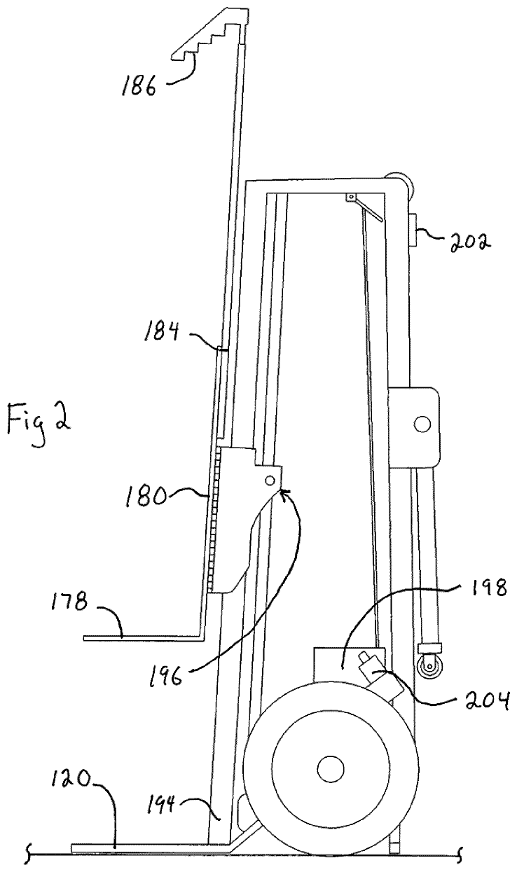

FIG. 3 is an elevation view of the left side of the dolly-panel carrier of FIG. 1 shown in the vertical orientation with the load support at the side and raised, and with the carrier wheel frame extended.

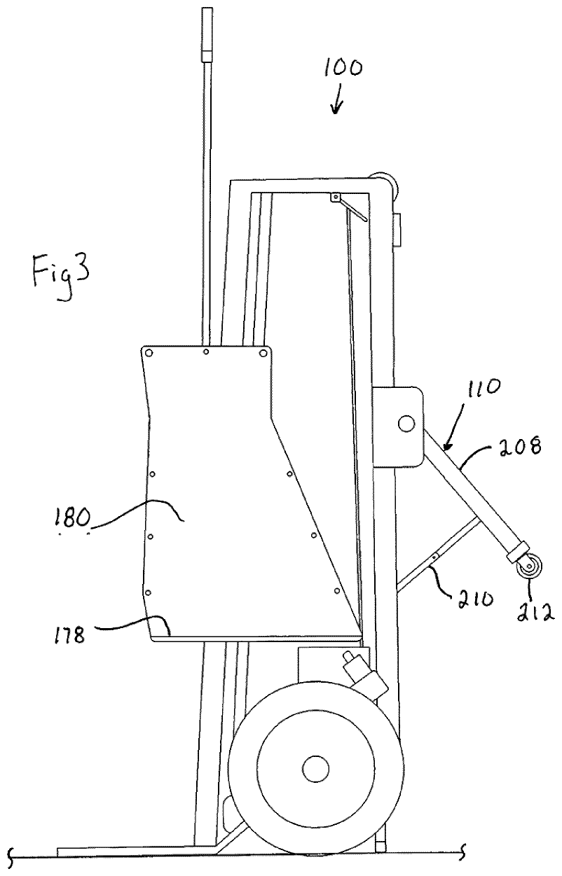

FIG. 4 is an elevation view of the left side of the dolly-panel carrier of FIG. 1 shown in the tilted orientation with the load support at the side and raised, and with the carrier wheel frame extended and the caster in contact with the floor.

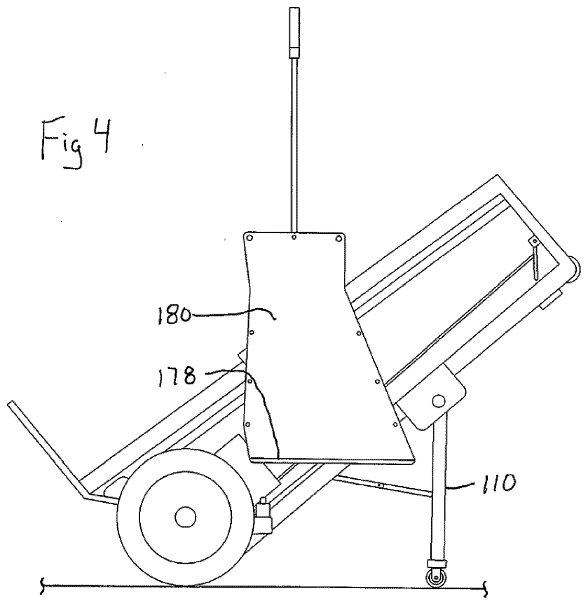

FIG. 5 is an elevation view of the left side of the dolly-panel carrier of FIG. 1 shown in the tilted orientation with the load support at the side and lowered to the panel transport position, and with the carrier wheel frame extended and the caster in contact with the floor.

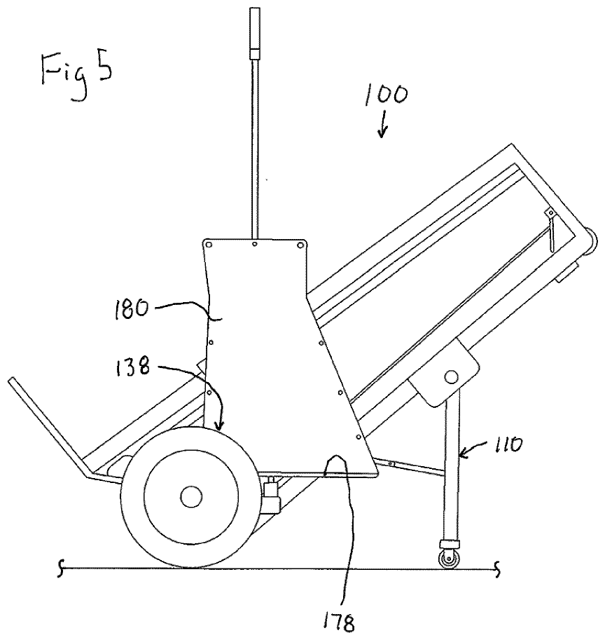

FIG. 6 is an elevation view of the right side of the dolly-panel carrier as shown in FIG. 5.

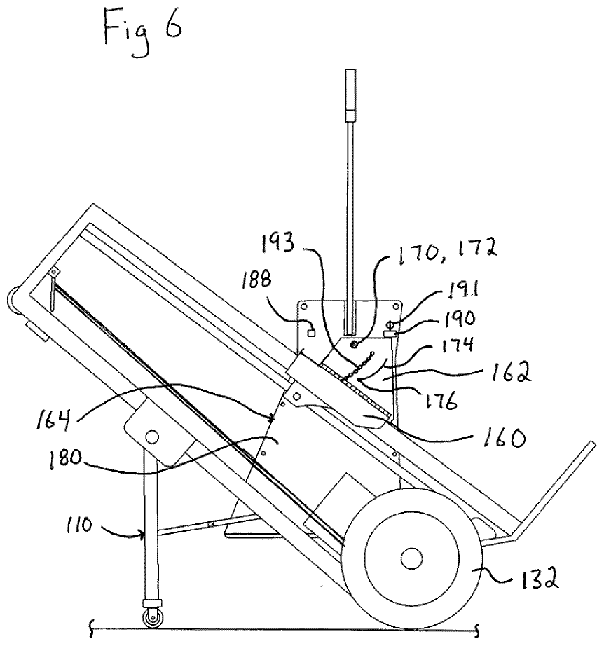

FIG. 7 is an elevation view of the front of a dolly, panel carrier and panel lift assembly embodiment of the present invention, shown with the panel lift installed on the dolly-panel carrier and with the panel support wings in the open panel support position.

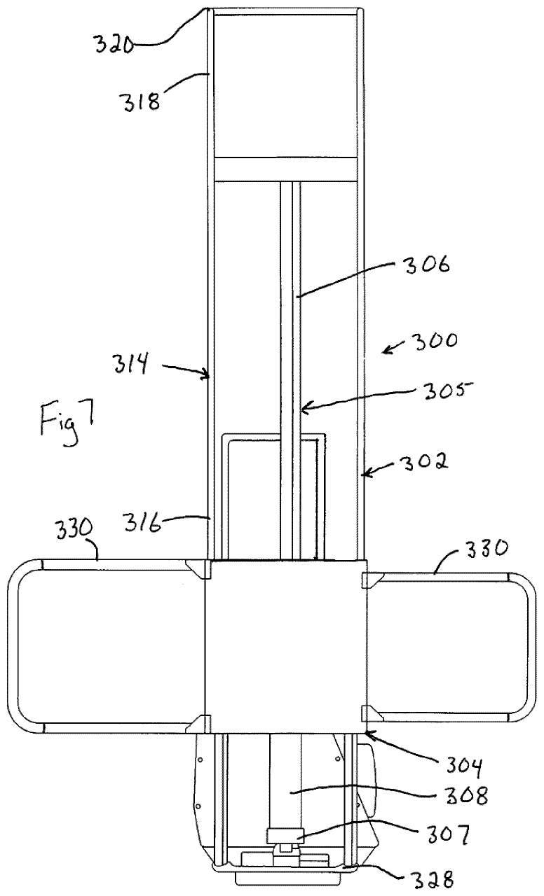

FIG. 8 is an elevation view of the left side of the dolly, panel carrier and panel lift embodiment, shown supporting a panel with the panel carriage in the vicinity of the lower end of the vertical track section.

FIG. 9 is an elevation view of the left side of the dolly, panel carrier and panel lift assembly embodiment, shown supporting a panel with the panel carriage approaching the upper end of the vertical track section.

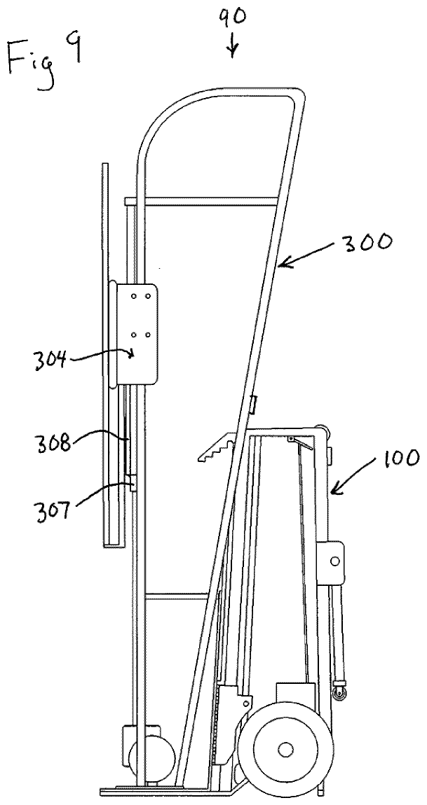

FIG. 10 is an elevation view of the left side of the dolly, panel carrier and panel lift assembly embodiment, shown supporting a panel with the panel carriage on the curved track section.

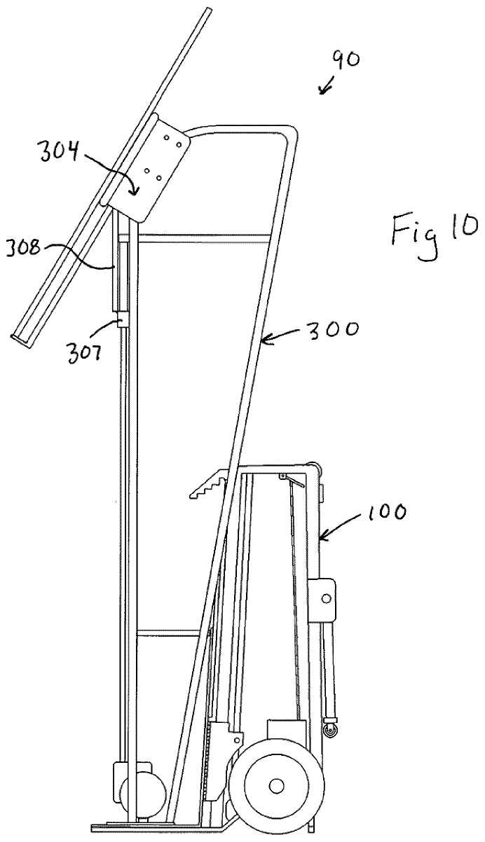

FIG. 11 is an elevation view of the left side of the dolly, panel carrier and panel lift assembly embodiment, shown supporting a panel with the panel carriage on the horizontal track section.

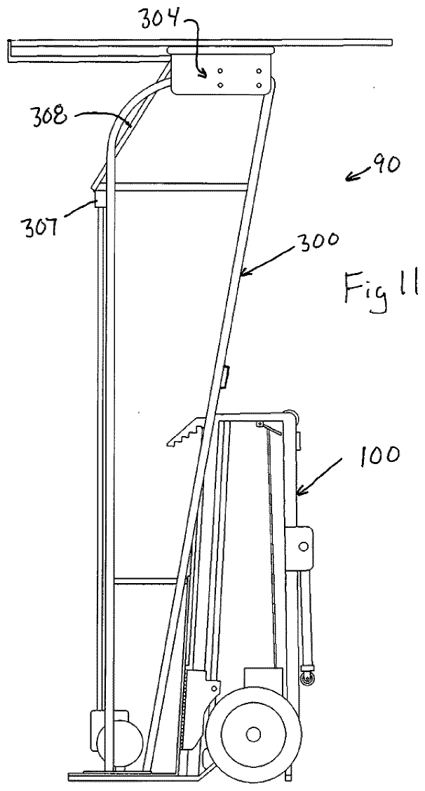

FIG. 12 is an elevation view of the left side of the dolly, panel carrier and panel lift assembly embodiment, shown supporting a panel with the panel carriage on the horizontal track section and the panel in position to be affixed to the ceiling.

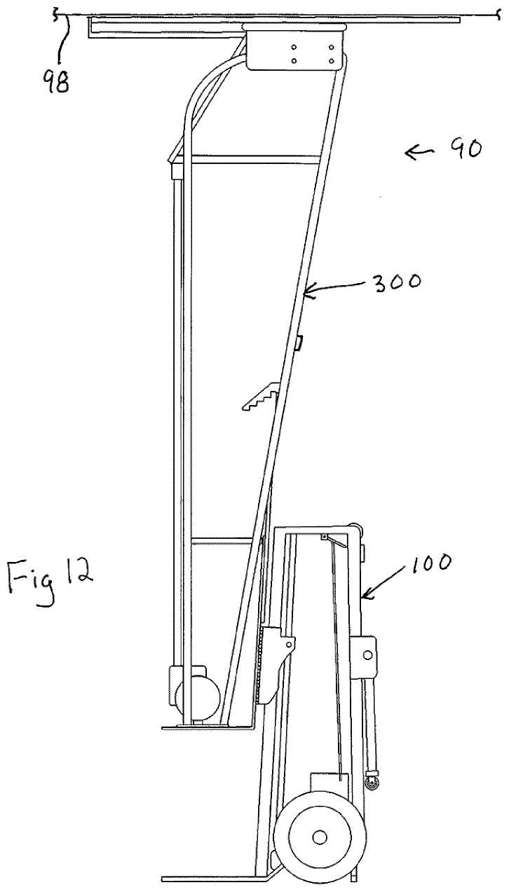

FIG. 13 is an elevation view of the left side of the dolly, panel carrier and panel lift assembly embodiment, shown supporting a panel with the panel carriage at the upper end of the vertical track section, with the panel coming into position to be affixed to the upper portion of the wall.

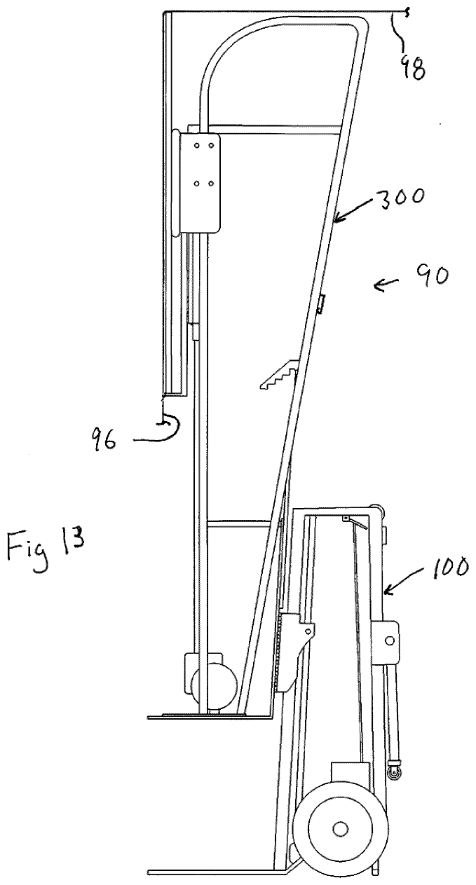

### DETAILED DESCRIPTION WITH REFERENCE TO THE DRAWINGS

Embodiments of the present invention include a dolly, panel carrier and panel lift assembly 90 embodiment, for use in transporting construction panels 92 across a generally horizontal supporting surface, e.g., a floor 94, and for raising and positioning a construction panel 92 for attachment to a wall 96 or a ceiling 98. The dolly, panel carrier and panel lift assembly 90 embodiment includes a dolly-panel carrier 100 and a panel lift 300.

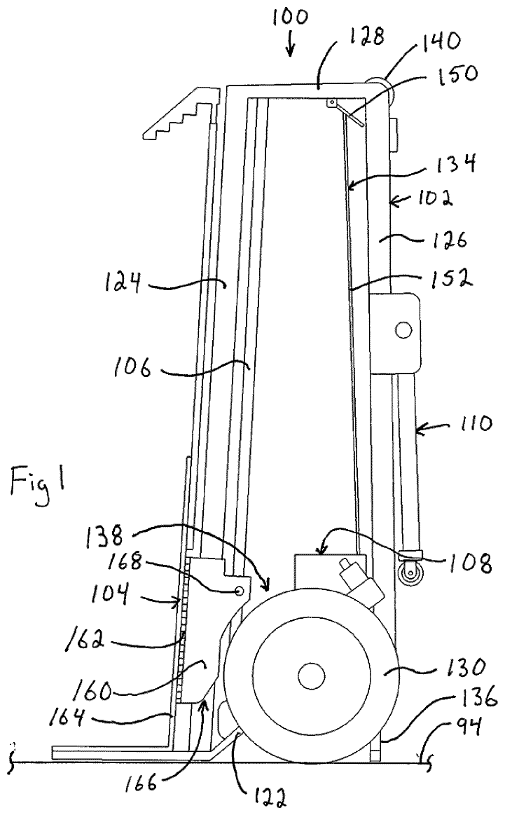

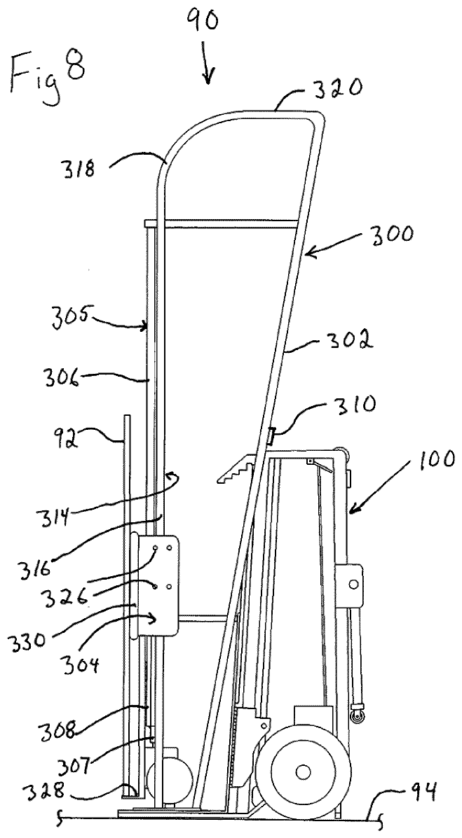

For clarity, in this specification, the “back” of the dolly, panel carrier and panel lift assembly 90 is the location where a user is conventionally positioned to propel and operate the dolly, panel carrier and panel lift assembly 90; the “left side” of the dolly, panel carrier and panel lift assembly 90 is on the left-hand side of a person standing at the back and facing toward the back of the dolly, panel carrier and panel lift assembly 90; the “right side” of the dolly, panel carrier and panel lift assembly 90 is on the right-hand side of a person standing at the back and facing toward the back of the dolly, panel carrier and panel lift assembly 90; and the “front” of the dolly, panel carrier and panel lift assembly 90 is opposite the “back”. As well, at times in this specification, terms implying absolute orientations and/or directions, e.g., upper, lower, below, above vertical, horizontal etc., are used for ease of explanation and generally apply to the dolly, panel carrier and panel lift assembly 90 when in the upright orientation, for example as indicated in FIGS. 1 and 8.

The dolly-panel carrier 100 includes a dolly frame 102, a load carriage 104 in slidable engagement with the dolly frame 102, a dolly linear actuator 106 drivably interposed between the dolly frame 102 and the load carriage 104, a dolly power/control assembly 108 and a carrier wheel assembly 110.

The dolly frame 102 includes a base plate 120, a bottom tray 122, two spaced-apart parallel carriage-support struts 124, two spaced-apart rear struts 126, a frame top 128, a left dolly wheel 130, a right dolly wheel 132, a brake assembly 134 and a kick stand 136.

The carriage-support struts 124 and rear struts 126 are attached to and project generally upward from the bottom tray 122. The upper ends of the carriage-support struts 124 and rear struts 126 are attached to the frame top 128, whereby the carriage-support struts 124, rear struts 126, bottom tray 122 and frame top 128 provide a strong rigid frame.

The left dolly wheel 130 and right dolly wheel 132 are rotatably attached to respective left and right sides of the bottom tray 122.

The carriage-support struts 124 and rear struts 126 are not centered on the bottom tray 122 in terms of a side to side orientation, but rather are offset (to the right side of the bottom tray 122 in the embodiment shown in the Figures and described herein), whereby the left dolly wheel 130, carriage-support strut 124 and rear strut 126 closest to the left dolly wheel 130, and the portion of the bottom tray 122 extending between the left dolly wheel 130 and that carriage-support strut 124 and rear strut 126, generally define a panel edge receiving hollow 138.

The base plate 120 extends frontward and is oriented to abut and overlie the floor 94 supporting the dolly-panel carrier 100 when the dolly-panel carrier 100 is in the upright orientation indicated in FIG. 1.

The frame top 128 includes a hand grip 140. The brake assembly 134 includes a brake lever 140 in the vicinity of the hand grip 140 and a brake connecting rod 152 extending between the brake lever 150 and brake components (not shown) associated with the wheels 130, 132 (e.g., brake bands, each mounted in association with a respective wheel hub; a brake actuator extending between, and operably connected to, the brake bands, and having a projecting brake actuator arm actuated by th brake connecting rod 152); such that a user may simultaneously grasp the hand grip 140 and the brake lever 150, whereby a user may apply braking force to the dolly wheels 130, 132 by drawing the brake lever 150 towards the hand grip 140, using one hand.

The kick stand 136 includes a kick stand leg pivotally mounted to the bottom tray 122, and a kick stand spring under tension and interconnecting the kick stand leg and bottom tray 122 in an over-center configuration. In the operable (i.e. down) position of the kick stand 136, the kick stand 136 and base plate 120 cooperate to maintain the dolly-panel carrier 100 in the upright orientation.

The load carriage 104 includes a car 160 in slidable engagement with the carriage-support struts 124; a pivot mount 162 hingedly mounted to the car 160 (wherein the pivot mount 162 may “swing” akin to a gate relative to the car 160); and a load support 164 pivotably mounted to the pivot mount 162 (wherein the pivot mount 162 and load support 164 each have a generally planar extent and share a common pivot axis substantially perpendicular to their generally planar extents).

The car 160 includes roller assemblies 166 that engage the carriage-support struts 124, and a car driven element mount 168.

The pivot mount 162 includes a pivot axis hole 170 through which the pivot bolt 172 is inserted and a stabilizing arcuate slot 174 through which the stabilizing bolt 176 is inserted (and secured with an oversize washer and a friction reducing material interposed between the washer and the pivot mount 162).

The load support 164 includes a ledge 178 and a ledge body 180. The ledge body 180 includes: a panel keeper mount 184 in which the panel keeper 186 is slidably and rotatably mounted; and two car-top abutments, a left car-top abutment 188 and a right car-top abutment 190 (for resting on adjacent parts of the top of the car 160 when the dolly-panel carrier 100 is in the upright orientation) the right car-top abutment 190 providing means (i.e. a quick release pin 191 and associated bores) for releasably securing the right car-top abutment 190 to the adjacent part of the top of the car 160. A support chain 193 is connected between the car 160 and pivot mount 162.

The car 160 and ledge body 180 may also include additional features for releasably securing one to the other when in the relative orientation shown in FIG. 1. For example, a latch on the car 160 and a latch slot on the ledge body 180, located below the right car-top abutment 190.

The dolly linear actuator 106 has a dolly linear actuator drive end 194 mounted adjacent the bottom tray 122 and a dolly linear actuator driven element 196 attached to the car driven element mount 168. In the embodiments shown in the Figures, the dolly linear actuator 106 is a 40-inch JIECANG™ model JC35L-1-21-24-1016/1216-H-B-0-B-14-4D5.

The dolly power/control assembly 108, includes the following interconnected components: a battery 198 (in this embodiment, two 12-V 7.2 Ah batteries connected in series to provide 24 volt DC), a fuse, a dolly rocker switch 202 (providing a default off position and manually applied up and down positions), a carrier limit switch 204 (shown in FIGS. 18-20), and a dolly power connector (for connecting to a battery charger or providing electrical power to the panel lift 300).

The carrier wheel assembly 110 includes a carrier wheel frame 208 pivotably mounted at its proximal end to the rear struts 126, a collapsible brace 210 interposed between the carrier wheel frame 208 and the rear struts 126, for releasably securing the carrier wheel assembly 110 in a projecting operable position; and a caster 212 mounted at the distal end of the carrier wheel frame 208.

The dolly-panel carrier 100 provides two operable positions, being a generally upright dolly position and a panel carrier position.

In the generally upright dolly position: the right car-top abutment 190 is secured to the adjacent part of the top of the car via the quick release pin 191 (and optionally by a load support latch engaged with a latch slot), and the dolly-panel carrier 100 may be used as a conventional dolly and as a powered dolly for raising loads supported by the ledge 178.

In the panel carrier position: the right car-top abutment 190 is disengaged from the adjacent part of the top of the car; the pivot mount 162 is oriented about 90 degrees relative to the car 160; the carrier wheel assembly 110 is in the projecting operable position; the dolly-panel carrier 100 is tilted from the generally upright position shown in FIG. 1 so as to bring the caster 212 into contact with the floor 94; the load support 164 is pivoted relative to the pivot mount 162 to bring the ledge 178 into substantial parallel alignment with the floor 94; and the lower portion of the load support 164 abutting the carrier limit switch 204 and the lower portion of the load support 164 is aligned with the panel receiving hollow 138. In the panel carrier position, the dolly-panel carrier 100 may be used to move conventional construction panels 92 through doorways and other relatively narrow openings.

One user may move the dolly-panel carrier 100 between the generally upright dolly position and the panel carrier position, with panels substantially centered (balanced) on the ledge 178, by: stabilizing the dolly-panel carrier 100 with the kick stand 136; raising the panels, using the dolly linear actuator 106, a sufficient height to clear the left dolly wheel when “swinging” the pivot mount 162 to bring the panels to the left side of the dolly-panel carrier 100; securing the carrier wheel assembly 110 in the projecting operable position; tilting the dolly frame 102 backward by gripping the hand grip 140 and brake lever 150 (to prevent rolling of the dolly-panel carrier 100) with the right hand while optionally steadying the panels with the left hand, so as to bring the caster 21 into contact with the floor 94, the tilting and gravity causing the load support 164 to pivot relative to the pivot mount 162; and lowering the panels using the dolly linear actuator 106 until the carrier limit switch 204 is triggered (i.e., the lower portion of the load support 164 is aligned with the panel receiving hollow 138).

The panel lift 300 includes a lift frame 302 and a panel carriage 304 in slidable engagement with the lift frame 302; a lift linear actuator 305 comprising a lift linear actuator body 306 and a lift linear actuator driven element 307 (in the embodiments shown in the Figures, the lift linear actuator 305 is a 60-inch JIECANG Model JC35L-0D75-25-24-1524/1724-H-B-0-B-22-0D18); a connecting bar 308; and a lift rocker switch 310 and lift power connector, interconnected with the lift linear actuator 305.

The lift frame 302 includes: a panel carriage track 314 having a vertical track section 316, a curved track section 318 and a horizontal track section 320. The lift frame 302 has features that releasably engage with mating features in the load support 164, for example downward projecting lift base stubs for engaging with receiving holes in the ledge 178 and substantially horizontally projecting lift retaining pins engaging with, and being releasably secured within, pin receiving holes in the ledge body 180.

The panel carriage 304 includes slide assemblies 326 that engage the panel carriage track 314; a single-panel ledge 328; and opposed adjustable panel support wings 330 (user movable between a folded storage/transport position, an open panel support position and, as each panel support wing 330 comprises telescoping components, an extended panel support position).

The connecting bar 308 is pivotably attached at one end to the lift linear actuator driven element 307, and the connecting bar 308 is pivotably attached at the other end to the panel carriage 304. The pivotable attachment between the connecting bar 308 and the lift linear actuator driven element 307 and the pivotable attachment between the connecting bar 308 and the panel carriage 304, enable the lift linear actuator 306 to propel the panel carriage 304 along the length of the carriage track 314, in that the pivotal attachments accommodate the change in orientation of the panel carriage 304 between generally vertical and generally horizontal as the panel carriage 304 moves between the vertical track section 316, curved track section 318 and horizontal track section 320.

The dolly, panel carrier and panel lift assembly 90 may be used to position a construction panel 92 for attachment to a ceiling 98, by using the lift linear actuator 305 to move the panel carriage 304 to the horizontal track section 320 and then using the dolly linear actuator 106 to raise the panel lift 300 so as to bring the construction panel 92 adjacent the ceiling 98. Alternatively, the dolly, panel carrier and panel lift assembly 90 may be used to position a construction panel 92 for attachment to the upper portion of a wall 96, by using the lift linear actuator 305 to raise the panel carriage 304 to the upper portion of the vertical track section 316 and then using the dolly linear actuator 106 to raise the panel lift 300 so as to bring the construction panel 92 to the desired position for attachment to the wall 96.

In this specification and the claims, the term “substantially” with respect to geometric relationships means within 20 degrees of an indicated angle. For example, substantially parallel means within 20 degrees of parallel and substantially normal means within 20 degrees of normal (i.e., perpendicular).

The scope of the claims should not be limited by the preferred embodiments set forth in the examples, but should be given the broadest interpretation consistent with the description as a whole.

1. Apparatus for carrying loads on a supporting surface, the loads including construction panels, each construction panel defining a notional unbounded construction panel plane, the apparatus comprising:
a dolly frame having a front, two sides and a back;
two wheels, each mounted on a respective side of the dolly frame, with both wheels rotatable about a single common wheel axis, and each wheel having an outer circumference wherein the outer circumferences of the wheels define a notional wheel cylinder extending between the wheels;
a load carriage comprising a load support having:
a load ledge for supporting loads and defining a load ledge plane; and
a load ledge body for stabilizing loads and defining a load ledge body plane;
wherein the load ledge plane and load ledge body plane intersect at a load ledge line; and
wherein the load support is reversibly user-moveable relative to the dolly frame between:
a front carry position wherein the load ledge line is substantially parallel to the wheel axis of rotation; and
a side carry position wherein the load support is usable to carry at least one construction panel, with each such carried construction panel's construction panel plane intersecting the wheel cylinder and substantially normal to the wheel axis.

2. The apparatus of claim 1, wherein in the side carry position, the load ledge line intersects the wheel cylinder.

3. The apparatus of claim 1, wherein:
the dolly frame has a longitudinal extent; and
the load carriage is in slidable engagement with the dolly frame so as to permit reversible movement of the load support along the longitudinal extent of the dolly frame.

4. The apparatus of claim 3, further comprising a dolly raise assembly for reversible user-controlled movement of the load carriage along the longitudinal extent of the dolly frame.

5. The apparatus of claim 4, wherein the dolly raise assembly comprises a dolly linear actuator.

6. The apparatus of claim 3, wherein the load carriage further comprises:
a car in the slidable engagement with the dolly frame; and
a hinged relationship between the load support and the car;
wherein the reversible user movement of the load support relative to the dolly frame between the front carry position and the side carry position, involves:
the reversible movement of the car along the longitudinal extent of the dolly frame; and
hinged movement of the load support relative to the car.

7. The apparatus of claim 6, wherein:
the hinged relationship between the load support and the car is provided by a pivot mount interposed between the load support and the car, wherein:
the pivot mount is hingedly mounted to the car; and
the load support is pivotably mounted to the pivot mount wherein the load support is pivotable relative to the pivot mount about a pivot axis substantially normal to the load ledge body plane; and
the reversible user movement of the load support relative to the dolly frame between the front carry position and the side carry position, further involves the pivotal movement of the load support relative to the pivot mount.

8. The apparatus of claim 7,
further comprising a back roller attached to the dolly frame wherein the dolly frame is user tiltable between a substantially upright orientation in which the back roller does not contact the supporting surface and a stable tilted orientation in which the wheels and back roller contact the supporting surface; and
wherein, in the reversible user movement of the load carriage relative to the dolly frame to the side carry position, the pivotal movement of the load support relative to the pivot mount orients the load ledge line to be substantially parallel to the supporting surface, in the stable tilted orientation.

9. The apparatus of claim 8, wherein the back roller is a caster and the attachment of the caster to the dolly frame comprises a caster mount user foldable between a retracted position and a projecting position.

10. The apparatus of claim 1,
wherein, the dolly frame comprises a frame top; and
further comprising:
a hand grip in the vicinity of the frame top; and
a brake assembly comprising:
a brake lever adjacent the hand grip and user moveable between a no brake position and a full brake position;
a brake mechanism at each wheel; and
a brake linkage interconnecting the brake lever and brake mechanism;
wherein the brake lever is positioned relative to the hand grip to permit the user to one-handedly grip the hand grip and brake lever in the full brake position.

11. The apparatus of claim 4, further comprising a panel lift releasably affixable to the load carriage for user selectively lifting and orienting a construction panel for attachment to a wall or ceiling.

12. The apparatus of claim 11, wherein the panel lift comprises:
a lift frame comprising:
at a proximal end of the lift frame, a load ledge engagement means for engagement with the load ledge in the affixing of the panel lift to the load carriage;
a panel carriage track extending from the vicinity of the proximal end to a distal end, the panel carriage track comprising:
a vertical track section extending from the vicinity of the proximal end;
a horizontal track section at the distal end; and
a curved track section connecting the vertical track section and horizontal track section;
a panel carriage in slidable engagement with the panel carriage track and comprising a single-panel ledge for supporting a construction panel;
a panel carriage raise assembly for reversible user-controlled movement of the panel carriage along the panel carriage track;
whereby, with the panel lift affixed to the load carriage, lifting and orienting a construction panel supported by the single-panel ledge, for attachment to:
a ceiling involves: using the panel carriage raise assembly to move the panel carriage and supported panel to the horizontal track section; and then using the dolly raise assembly to raise the panel assembly to bring the construction panel adjacent the ceiling; and
a wall involves: using the panel carriage raise assembly along the vertical track section and/or using the using the dolly raise assembly to raise the panel assembly, to move the construction panel to a desired height on the wall.

13. The apparatus of claim 12, wherein: the dolly raise assembly comprises a dolly linear actuator and the panel carriage raise assembly comprises a lift linear actuator.

14. The apparatus of claim 13 wherein the lift linear actuator is held in a rigid relationship with the lift frame and a connecting bar is interposed between the lift linear actuator and the panel carriage to accommodate changing orientations of the panel carriage during movement of the panel carriage between the vertical track section and the horizontal track section via the curved track section.

15. The apparatus of claim 13 wherein a battery is mounted in the dolly frame to power the dolly linear actuator and, when the panel lift is affixed to the load carriage, the battery is connectable to the lift linear actuator to power the lift linear actuator.

16. Apparatus for carrying loads on a supporting surface, the loads including construction panels, each construction panel defining a notional unbounded construction panel plane, the apparatus comprising:
a dolly frame having a front, two sides, a back and a longitudinal extent;
two wheels, each mounted on a respective side of the dolly frame, with both wheels rotatable about a single common wheel axis, and each wheel having an outer circumference wherein the outer circumferences of the wheels define a notional wheel cylinder extending between the wheels;
a load carriage comprising:
a car in the slidable engagement with the dolly frame so as to permit reversible movement of the car along the longitudinal extent of the dolly frame;
a pivot mount hingedly mounted to the car; and
a load support, comprising a load ledge for supporting loads and defining a load ledge plane; and a load ledge body for stabilizing loads and defining a load ledge body plane; wherein the load ledge plane and load ledge body plane intersect at a load ledge line;
wherein the load support is pivotably mounted to the pivot mount wherein the load support is pivotable relative to the pivot mount about a pivot axis substantially normal to the load ledge body plane; and
a dolly raise assembly for reversible user-controlled movement of the car along the longitudinal extent of the dolly frame;
wherein the load support is reversibly user-moveable relative to the dolly frame between:
a front carry position wherein the load ledge line is substantially parallel to the wheel axis of rotation; and
a side carry position wherein the load ledge line intersects the wheel cylinder and the load carriage is usable to carry at least one construction panel, with each such carried construction panel's construction panel plane intersecting the wheel cylinder and substantially normal to the wheel axis;
wherein the reversible user movement of the load carriage relative to the dolly frame between the front carry position and the side carry position, involves: the reversible movement of the car along the longitudinal extent of the dolly frame; the hinged movement of the load support relative to the car; and the pivotal movement of the load support relative to the pivot mount.

17. The apparatus of claim 16, wherein the dolly raise assembly comprises a dolly linear actuator.

18. The apparatus of claim 16, further comprising a back roller attached to the dolly frame wherein the dolly frame is user tiltable between a substantially upright orientation in which the back roller does not contact the supporting surface and a stable tilted orientation in which the wheels and back roller contact the supporting surface; and
wherein, in the reversible user movement of the load carriage relative to the dolly frame to the side carry position, the pivotal movement of the load support relative to the pivot mount orients the load ledge line to be substantially parallel to the supporting surface, in the stable tilted orientation.

19. Apparatus for carrying loads on a supporting surface and for user selectively lifting and orienting a construction panel for attachment to a wall or ceiling, the apparatus comprising:
a dolly frame having a front, two sides, a back and a longitudinal extent;
two wheels mounted to the dolly frame and a having a single common axis of rotation;
a load carriage in slidable engagement with the dolly frame so as to permit reversible movement of the load carriage along the longitudinal extent of the dolly frame;
a dolly raise assembly for reversible user-controlled movement of the load carriage along the longitudinal extent of the dolly frame; and
a panel lift releasably affixable to the load carriage and comprising:
a lift frame comprising:
at a proximal end of the lift frame, a load carriage engagement means for engagement with the load carriage in the affixing of the panel lift to the load carriage;
a panel carriage track extending from the vicinity of the proximal end to a distal end, the panel carriage track comprising: a vertical track section extending from the vicinity of the proximal end; a horizontal track section at the distal end; and a curved track section connecting the vertical track section and horizontal track section;
a panel carriage in slidable engagement with the panel carriage track and comprising a single-panel ledge for supporting a construction panel;
a panel carriage raise assembly for reversible user-controlled movement of the panel carriage along the panel carriage track;
whereby, with the panel lift affixed to the load carriage, lifting and orienting a construction panel supported by the single-panel ledge, for attachment to:
a ceiling involves, using the panel carriage raise assembly to move the panel carriage and supported panel to the horizontal track section; and then using the dolly raise assembly to raise the panel assembly to bring the construction panel adjacent the ceiling; and
a wall involves, using the panel carriage raise assembly along the vertical track section and/or using the using the dolly raise assembly to raise the panel assembly, to move the construction panel to a desired height on the wall.

20. The apparatus of claim 19, further comprising a user operable kick stand attached to the dolly frame for stabilizing the apparatus when lifting and orienting a construction panel.
